(19) United States
(12) Patent Application Publication
(10) Pub. No.: US 2010/0058391 A1
(43) Pub. Date: Mar. 4, 2010

(54) SYSTEM AND METHOD FOR ACCOMMODATION OF DIGITAL AND ANALOG CHANNEL NUMBER CONFLICTS

(76) Inventors: Steven L. Cooper, Whitestown, IN (US); Bret D. Hawkins, Brownsburg, IN (US)

Correspondence Address: FLETCHER YODER P.C., 7915 FM 1960 RD. WEST, SUITE 330, HOUSTON, TX, 77070, US

(21) Appl. No.: 12/444,798

(22) PCT Filed: Oct. 23, 2006
(86) PCT No.: PCT/US2006/041206

§ 371 Date: Apr. 8, 2009

(51) Int. Cl. H04N 5/445

(52) U.S. Cl. 725/56

(57) ABSTRACT

There is provided a system and method for accommodation of digital and analog channel number conflicts. More specifically, in one embodiment, there is provided a method, comprising detecting an analog video signal with a channel number, detecting a digital video signal with the channel number, storing the analog video signal in a channel database with a first reference value, and storing the digital video signal in the channel database with a second reference value, the second reference value being different from the first reference value.

### CROSS-REFERENCE TO RELATED APPLICATIONS

This application is a National Phase 371 Application of PCT Application No. PCT/US06/041206, filed Oct. 23, 2006, entitled “SYSTEM AND METHOD FOR ACCOMMODATION OF DIGITAL AND ANALOG CHANNEL NUMBER CONFLICTS”.

### FIELD OF THE INVENTION

The present invention relates generally to searching and negotiating digital and analog television channels.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Digital cable, a service offered by many cable distributors, utilizes digital technology to facilitate provision of a larger number of channels to users than would be available with analog channels alone. Using video compression and digital channels, cable distributors may increase the number and diversity of programs available on their existing cable networks without requiring network additions.

Cable television channels may support multiple digital subchannels. For example, a single channel may be utilized to broadcast multiple compressed subchannels. Accordingly, as is the case with the ATSC (Advanced Television Systems Committee) 65 standard, digital channel numbers often use a two-part format. For example, a digital channel number may be “9-2,” which refers to the second subchannel of channel nine. However, the ANSI/SCTE (American National Standards Institute/Society of Cable Telecommunications Engineers) 65 standard differs from the ATSC 65 standard in its specification of virtual channel numbers. For example, the ANSI/SCTE 65 standard adds the possibility of a one-part virtual channel number. As appreciated by those of ordinary skill in the art, conflicts may arise between channels because of the use of potentially conflicting channel assignment strategies. A system and method that effectively resolves conflicts between channels is desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for accommodation of digital and analog channel number conflicts. More specifically, in one embodiment, there is provided a method, comprising detecting an analog video signal with a channel number, detecting a digital video signal with the channel number, storing the analog video signal in a channel database with a first reference value, and storing the digital video signal in the channel database with a second reference value, the second reference value being different from the first reference value.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention;

FIG. 2 is a process flow diagram representing cable channel map processing in accordance with an exemplary embodiment of the present invention;

FIG. 3 is a process flow diagram representing a procedure for accommodating potential channel number conflicts in accordance with an exemplary embodiment of the present invention;

FIG. 4 is a process flow diagram representing another procedure for accommodating potential channel number conflicts in accordance with an exemplary embodiment of the present invention;

FIG. 5 is a process flow diagram representing another procedure for accommodating potential channel number conflicts in accordance with an exemplary embodiment of the present invention;

FIG. 6 is a process flow diagram representing another procedure for accommodating potential channel number conflicts in accordance with an exemplary embodiment of the present invention;

FIG. 7 is a process flow diagram representing another procedure for accommodating potential channel number conflicts in accordance with an exemplary embodiment of the present invention; and

FIG. 8 is a process flow diagram representing a procedure for selecting channels when both digital and analog channels with the same value are present in a channel map in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

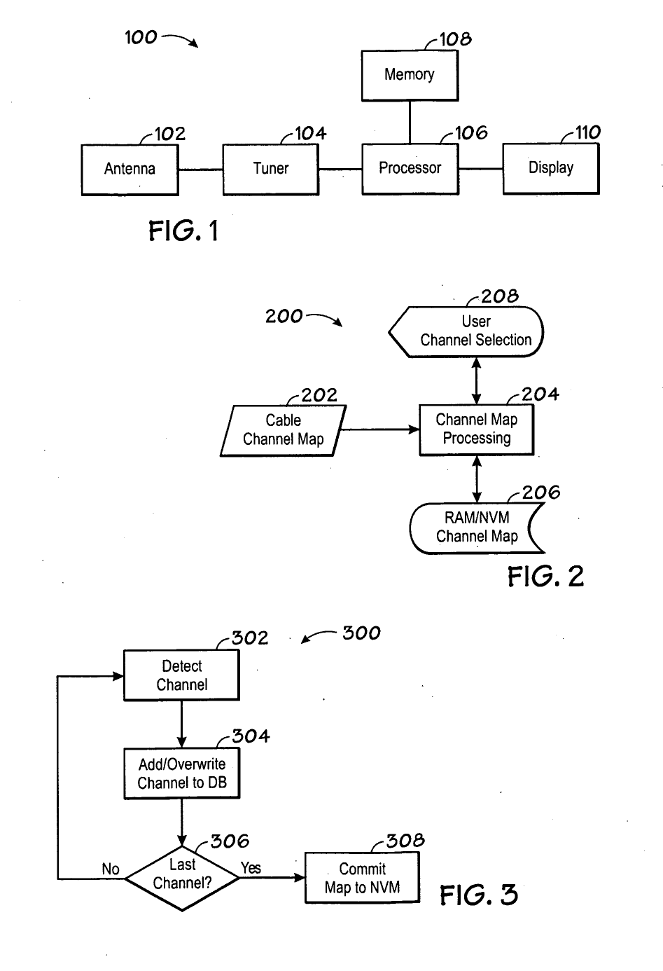

FIG. 1 is a block diagram of an electronic device in accordance with an exemplary embodiment of the present invention. The electronic device (e.g., a television) is generally referred to by the reference number 100. The electronic device 100 comprises a receptor (e.g., a cable inlet or an antenna), a tuner 104, a processor 106, a memory 108, and a display 110. The memory 108 may be adapted to hold machine-readable computer code that causes the processor 106 to perform an exemplary method in accordance with the present invention.

FIG. 2 is a process flow diagram 200 representing cable channel map processing in accordance with an exemplary embodiment of the present invention. Specifically, FIG. 2 illustrates a cable channel map 202 that may be processed in block 204 by a channel map processing unit and added to a channel map database 206 stored in random access memory (RAM), non-volatile memory (NVM) or the like. For example, mapping channels (e.g., video signals) and storing them in memory may include searching available channels and mapping those with a sufficiently clear signal. Further, block 208 represents selection of channels for display by a user. For example, this may include selecting certain channel numbers on a television panel or remote control for display of the associated content on a television screen.

Many televisions are configured to perform a channel search operation to identify valid channels when the television is initially set up or when a program source is changed. Such a search operation generally detects channels that carry a valid program signal. If a signal is present during the search operation, the channel is added or mapped to the channel database stored in non-volatile memory. After the search operation is performed, channels identified as not having valid program signals are essentially ignored and not shown during typical operation of the television. Moreover, such channels with no valid signal are typically skipped when the user presses the “channel up” or “channel down” button on the television controls.

A channel search operation may identify both analog and digital cable channels that are available to a television. In view of the possibility of a one-part virtual channel number for a digital channel, it is now recognized that the potential exists for a search operation to identify multiple valid program signals with the same channel number. In other words, a valid digital channel and a valid analog channel may have the same channel number. Indeed, it is theoretically possible for a broadcaster to choose a one-part channel number (virtual channel) for a digital channel such that the selected channel number conflicts with an existing analog channel number. Accordingly, embodiments of the present invention address such potential conflicts and employ procedures to avoid conflicts and/or provide access to all available channels.

FIG. 3 is a block diagram representing a procedure for accommodating potential channel number conflicts in accordance with an exemplary embodiment of the present invention. The procedure may generally be referred to by reference numeral 300. According to procedure 300, in the event that analog and digital channel numbers are in conflict, only the last number detected is selected for commitment to a channel map (e.g., a database store in the memory 108). For example, if a digital channel is detected and then an analog channel is detected with the same number as the digital channel, the analog channel will overwrite the digital channel because the analog channel was detected last. If the digital channel were detected last, it would overwrite the analog channel.

Specifically, procedure 300 includes detecting a channel, as represented by block 302. This may consist of detecting a valid analog or digital channel (e.g., a channel with valid programming or with a signal that is sufficiently clear for viewing) in a sequence or group of available channels. If a valid channel is detected, the channel may be included in a database of channels, as represented by block 304. After each channel is detected and/or included in the channel map, it is determined in block 306 whether the most recently detected channel is the last channel to be included. For example, it may be the last channel to be searched in a range of channels. If it is not the last channel, the procedure may continue at block 302. If it is determined to be the last channel, the database of valid channels or channel map may be committed to memory in block 308.

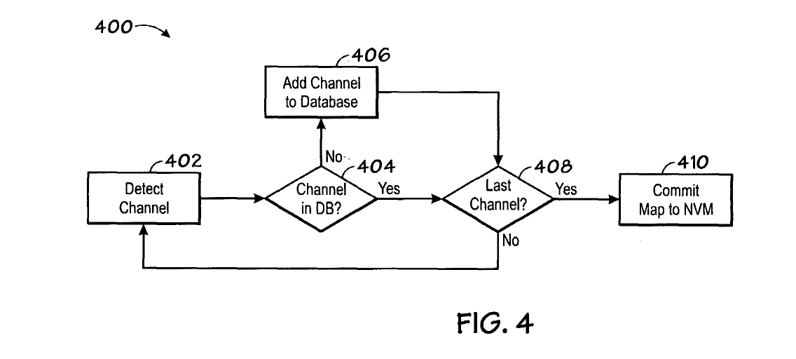

FIG. 4 is a block diagram representing another procedure for accommodating potential channel number conflicts in accordance with an exemplary embodiment of the present invention. The procedure may generally be referred to by reference numeral 400. According to procedure 400, in the event that analog and digital channel numbers are in conflict, only the first number detected is selected for commitment to a channel map (e.g., a database store in the memory 108). For example, if a digital channel is detected and then an analog channel is detected with the same number as the digital channel, the digital channel will be retained for inclusion in the channel map and the analog channel will be essentially ignored because it was detected after the digital channel. If the digital channel were detected last, it would be ignored and the analog channel would be retained.

Specifically, procedure 400 includes detecting a channel, as represented by block 402. This may consist of detecting a valid analog or digital channel in a sequence or group of available channels. If a valid channel is detected, it is determined whether the channel number is already present in a database of channels, as represented by block 404. If it is already present, the procedure 400 continues without storing the recently detected channel. If the detected channel is not already present in the database, it is included therein, as represented by block 406. After each channel is detected and/or included in the channel map, it is determined in block 408 whether the most recently detected channel is the last channel to be included. For example, it may be the last channel to be searched in a range of channels. If it is not the last channel, the procedure may continue at block 402. If it is determined to be the last channel, the database of valid channels or channel map may be committed to memory in block 410.

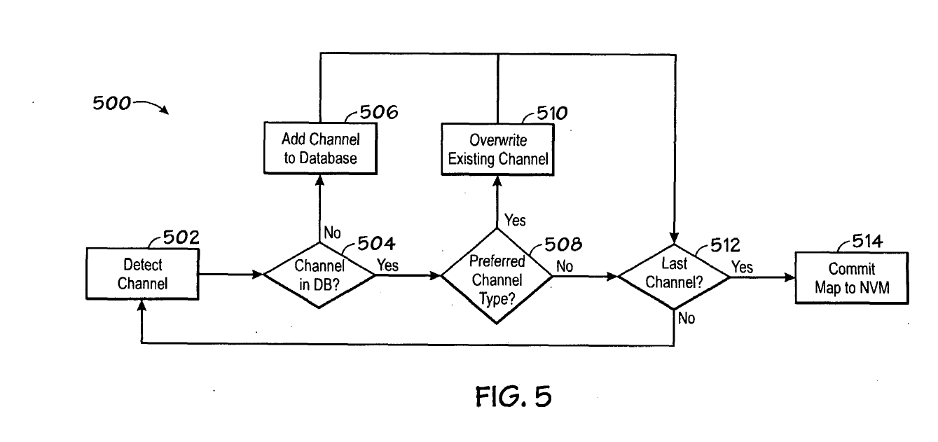

FIG. 5 is a block diagram representing another procedure for accommodating potential channel number conflicts in accordance with an exemplary embodiment of the present invention. The procedure may generally be referred to by reference numeral 500. According to procedure 500, in the event that analog and digital channel numbers are in conflict, only the digital number or only the analog number is selected for commitment to a channel map (e.g., a database store in the memory 108) based on a preference. For example, when digital channels are the preference, if both a digital channel and an analog channel are detected with the same number, the digital channel will be retained for inclusion in the channel map because it is preferred. The analog channel will either be ignored or overwritten by the digital channel. If analog channels are preferred, the opposite will occur.

Specifically, procedure 500 includes detecting a channel, as represented by block 502. This may consist of detecting a valid analog or digital channel in a sequence or group of available channels. If a valid channel is detected, it is determined whether the channel number is already present in a database of channels, as represented by block 504. If the detected channel is not already present in the database, it is included therein, as represented by block 506. If it is already present, the procedure 500 continues to a preference query represented by block 508. In block 508 it is determined whether the detected channel is the preferred channel type (i.e., digital or analog). If the detected channel is the preferred type, it overwrites the existing channel, as illustrated by block 510. Otherwise, the procedure continues without storing the recently detected channel. After each channel is detected and/or included in the channel map, it is determined in block 512 whether the most recently detected channel is the last channel to be included. For example, it may be the last channel to be searched in a range of channels. If it is not the last channel, the procedure may continue at block 502. If it is determined to be the last channel, the database of valid channels or channel map may be committed to memory in block 514.

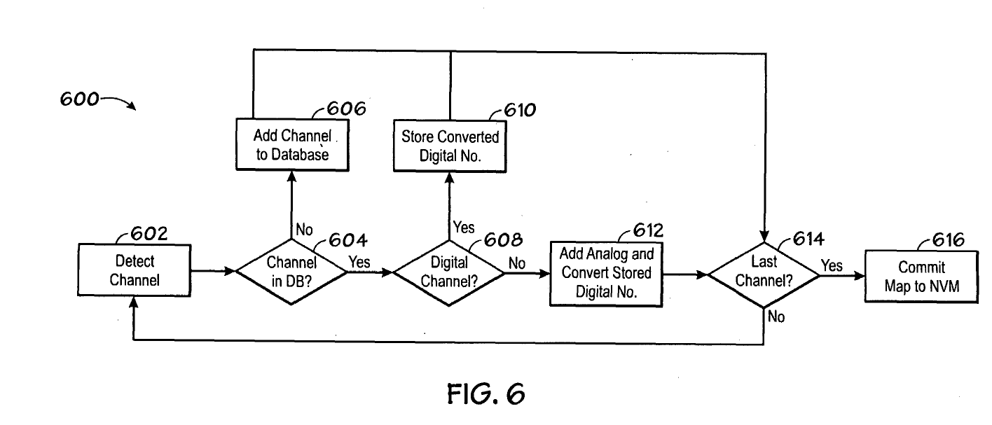

FIG. 6 is a block diagram representing another procedure for accommodating potential channel number conflicts in accordance with an exemplary embodiment of the present invention. The procedure may generally be referred to by reference numeral 600. According to procedure 600, in the event that analog and digital channel numbers are in conflict, the digital channel number (virtual channel) is converted to a physical channel number. For example, if both a digital channel and an analog channel are detected with the same number (i.e., the virtual digital channel number is the same as a detected analog channel number), the digital channel number will be converted to a physical channel number. Specifically, for example, a virtual channel (e.g., “9”) assigned to the digital channel may be converted to a two part physical channel number (e.g., “48-2”) based on the physical channel and subchannel for the digital channel. Thus, conflict between equivalent channel values may be avoided. Further, both the analog and digital channel numbers may be mapped and may remain available for selection by a user.

Specifically, procedure 600 includes detecting a channel, as represented by block 602. This may consist of detecting a valid analog or digital channel in a sequence or group of available channels. If a valid channel is detected, it is determined whether the channel number is already present in a database of channels, as represented by block 604. If the detected channel is not already present in the database, it is included therein, as represented by block 606. If it is already present in the database, the procedure 600 continues to a data type query represented by block 608. In block 608 it is determined whether the detected channel is digital or analog. If the detected channel is digital, it is converted to the corresponding physical channel number and then stored in the database, as illustrated by block 610. If the detected channel is analog (e.g., not digital), the procedure continues to block 612, wherein the previously stored digital number is converted to the corresponding physical channel number and the detected analog channel is also stored in the database. After each channel is detected, converted, and/or included in the channel map, it is determined in block 614 whether the most recently detected channel is the last channel to be included. For example, it may be the last channel to be searched in a range of channels. If it is not the last channel, the procedure may continue at block 602. If it is determined to be the last channel, the database of valid channels or channel map may be committed to memory in block 616.

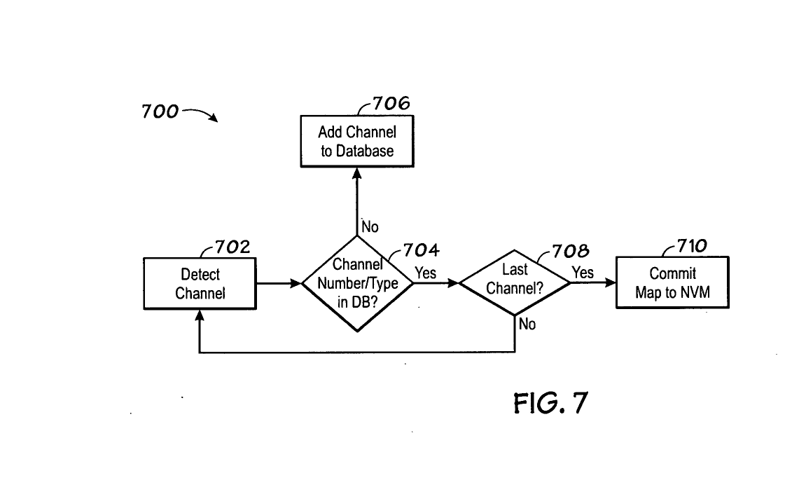

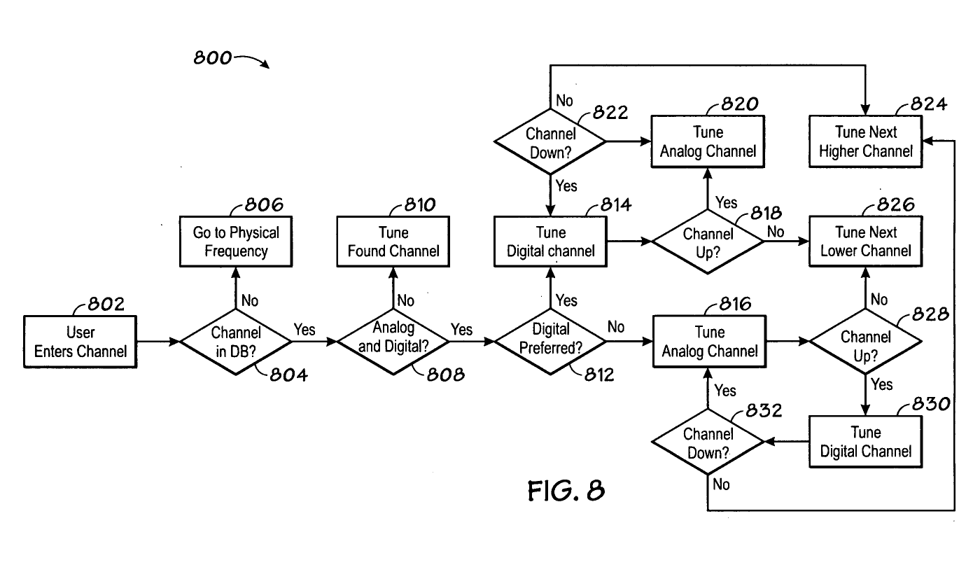

FIG. 7 is a block diagram representing another procedure for accommodating potential channel number conflicts in accordance with an exemplary embodiment of the present invention. The procedure may generally be referred to by reference numeral 700. According to procedure 700, in the event that analog and digital channel numbers are in conflict, the digital channel number and the analog number are both retained and committed to a channel map. Specifically, procedure 700 includes detecting a channel, as represented by block 702. If a valid channel is detected, it is determined whether the channel number of that channel type is already present in a database of channels, as represented by block 704. If the detected channel of its type is not already present in the database, it is included therein, as represented by block 706. Block 706 may include assigning the channel to a different reference value to distinguish channel types. If the detected channel (type and number) is already present in the database, the procedure 700 continues to block 708 to determine whether the most recently detected channel is the last channel to be included. If it is not the last channel, the procedure may continue at block 702. If it is determined to be the last channel, the database of valid channels or channel map may be committed to memory in block 710. Because both analog and digital numbers are retained, the channels may later be distinguished by manner of selection, as illustrated in FIG. 8.

FIG. 8 is a block diagram representing a procedure for selecting channels when both digital and analog channels with the same value are present in a channel map in accordance with an exemplary embodiment of the present invention. The procedure may generally be referred to by reference numeral 800 and may compliment other procedures set forth above, such as procedure 600 and procedure 700. Procedure 800 includes channel selection, as represented by block 802. For example, procedure 800 may be implemented with electronic device 100 to view a specific broadcast on electronic device 100. Once a channel number is entered in block 802, it is determined in block 804 whether the channel is present in a channel database. If the channel is not present in the database, the procedure may be directed to the physical frequency corresponding to the entered channel, as represented by block 806. If the channel number is present in the database, the procedure 800 may continue to an analog and digital query, as represented by block 808. In block 808, it is determined whether both analog and digital channels with the same channel number are present in the database. If both types of the entered channel are not present, the found channel may be tuned, as represented by block 810. If both types of the entered channel are present, a preference channel type is determined in block 812. If digital is preferred, the digital channel is tuned, as represented by block 814. If analog is preferred, the analog channel is tuned, as represented by block 816.

Procedure 800 also includes features that facilitate access to the non-preferred channel type that is stored. For example, once the preferred channel is tuned (e.g., blocks 814 and 816), a user may access the non-preferred channel by channeling up or down (e.g., pressing an up or down button) using a remote control or control panel on the electronic device 100. One embodiment of this procedure is incorporated in the procedure 800, as illustrated. For example, once the preferred digital channel is tuned in block 814, a channel up may be detected in block 818. If a channel up is detected, the corresponding analog channel may be tuned, as illustrated in block 820. Once the analog channel is tuned in block 820, the digital channel may be tuned again in block 814 if a channel down is detected in block 822. If a channel up is detected in block 822, a higher channel may be tuned in block 824. If a channel down is detected while tuned to the digital channel in block 814, the next lower channel may be tuned, as illustrated by block 826. Similarly, once the preferred analog channel is tuned in block 816, a channel up may be detected in block 828. If a channel up is detected, the corresponding digital channel may be tuned, as illustrated in block 830. Once the digital channel is tuned in block 830, the analog channel may be tuned again in block 816 if a channel down is detected in block 832. If a channel up is detected in block 832, a higher channel may be tuned in block 824. If a channel down is detected while tuned to the analog channel in block 816, the next lower channel may be tuned, as illustrated by block 826. It should be noted that in other embodiments, the up and down channel conventions may be reversed.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
detecting an analog video signal with a channel number;
detecting a digital video signal with the channel number;
storing the analog video signal in a channel database with a first reference value; and
storing the digital video signal in the channel database with a second reference value, the second reference value being different from the first reference value.

2. The method of claim 1, comprising storing the digital video signal in the channel database with a physical channel number of the digital video signal as the second reference value.

3. The method of claim 1, comprising converting the channel number for the digital video signal to a physical channel number of the digital video signal when the analog video signal is detected with the channel number.

4. The method of claim 1, comprising:
receiving an input channel; and
detecting whether the input channel is in the database.

5. The method of claim 4, comprising selecting a physical frequency associated with the input channel if the input channel is not present in the database.

6. The method of claim 4, comprising tuning to an associated analog or digital signal of the input channel if the input channel is found to be present in the database and only the analog or the digital signal is associated with the input channel.

7. The method of claim 4, comprising:
detecting both an analog version and a digital version of the input channel in the database;
determining whether the analog or the digital version is preferred; and
tuning to the preferred version.

8. The method of claim 7, comprising tuning to the non-preferred version when a channel up or channel down is detected.

9. The method of claim 7, comprising tuning to a next higher or next lower channel in the database when a channel up or channel down is detected.

10. A method comprising:
detecting an analog video signal with a channel number;
detecting a digital video signal with the channel number; and
storing only one of the analog signal or the digital video signal in a database based on a preference criterion.

11. The method of claim 10, comprising not selecting whichever of the analog video signal or the digital video signal is detected second for storage in the database, wherein the preference criterion is an order of detection.

12. The method of claim 10, comprising overwriting the analog video signal with the digital video signal, wherein the preference criterion is a digital preference.

13. The method of claim 10, comprising overwriting the digital video signal with the analog video signal, wherein the preference criterion is an analog preference.

14. The method of claim 10, comprising determining whether the channel number is a last channel.

15. The method of claim 14, comprising committing the database to a memory if the channel number is the last channel.

16. A method comprising:
detecting at least one pair of analog and digital video signals with a conflicting channel number;
storing both the analog and digital video signals in a channel database;
receiving an input channel; and
detecting whether the input channel is in the channel database.

17. The method of claim 16, comprising selecting a physical frequency associated with the input channel if the input channel is not present in the database.

18. The method of claim 16, comprising tuning to an associated analog or digital signal of the input channel if the input channel is found to be present in the database and only the analog or the digital signal is associated with the input channel.

19. The method of claim 16, comprising:
detecting that the input channel corresponds to both the digital and analog video signals;
determining whether the analog or the digital video signal is preferred; and
tuning to the preferred video signal.

20. The method of claim 19, comprising tuning to the non-preferred version when a channel up or channel down is detected.
